(19) United States
(12) Patent Application Publication
(10) Pub. No.: US 2007/0250715 A1
(43) Pub. Date: Oct. 25, 2007

(54) FILE SHARING CONTROL USING DIGITAL WATERMARKS

(76) Inventors: Yigang Cai, Naperville, IL (US); Alexander Aihao Yin, QingDao (CN)

Correspondence Address: DUFT BORNSEN & FISHMAN, LLP, 1526 SPRUCE STREET, SUITE 302, BOULDER, CO, 80302, US

(21) Appl. No.: 11/379,339

(22) Filed: Apr. 19, 2006

(51) Int. Cl. H04L 9/32; H04N 7/16; H04L 9/00; G06K 9/00; G06F 17/30; G06F 7/04; H03M 1/68; H04K 1/00

(52) U.S. Cl. 713/176; 726/26; 726/27; 726/2; 713/165; 713/167

(57) ABSTRACT

Systems, methods, and software products are disclosed that control file sharing of copyright protected electronic files over a communication network. A digital watermark in an electronic file includes information on content servers that are authorized to download to the electronic file to a requesting party. When the electronic file is downloaded from a particular content server to a requesting party, the information on the authorized content servers in the digital watermark is processed to determine if the downloading content server is authorized to be downloading the electronic file. If the downloading content server is authorized, then the downloading of the electronic file is allowed to continue. If the downloading content server is not authorized, then the electronic file is blocked from being downloaded to the requesting party.

### BACKGROUND OF THE INVENTION

1. Field of the Invention

The invention is related to the field of communications and, in particular, to providing systems and methods that control the sharing of electronic files over a communication network using digital watermarks.

2. Statement of the Problem

Music, images, films, software, and other types of electronic files are often copyright protected by the owner/creator of the file. Electronic files may be protected using a digital watermark. A digital watermark is a small set of programmed code embedded into an electronic file that includes copyright information. The digital watermark can be read by a corresponding application that runs on a PC or other device attempting to open or duplicate the file. For copyright protection, the application performs strict checking on the copyright information included in the digital watermark to prevent illegal users from opening or duplicating unauthorized files.

More and more copyright protected files are sold and distributed using the internet. These files are normally stored on content servers on the internet that are adapted to download the files to requesting parties. One present problem is that there are not efficient methods for protecting copyright protected files from being shared over the Internet. The applications running on the access devices of the requesting parties may be able to protect from opening or duplicating the files once received by the access devices, but the applications are not able to protect against file sharing over the internet.

### SUMMARY OF THE SOLUTION

The invention solves the above and other problems by controlling file sharing over a communication network using digital watermarks. In addition to the information that is traditionally included in a digital watermark of an electronic file, the digital watermark also includes information on content servers that are authorized to download the electronic file over the communication network to a requesting party. When the file is subsequently being downloaded by a content server to a requesting party over the communication network, systems in the communication network and/or the access device of the requesting party checks the digital watermark to determine if the content server downloading the electronic files is authorized to do so. The downloading process may be blocked if the content server downloading the file is not authorized. The digital watermarks can thus advantageously be used to protect against illegal or unauthorized file sharing over the communication network.

One embodiment of the invention comprises a method of protecting an electronic file from being shared over a communication network using digital watermarks. One step of the method includes identifying one or more content servers authorized to provide a copyright protected electronic file to requesting parties. Another step of the method includes encoding, inserting, or otherwise including information on the authorized content servers in a digital watermark in the electronic file. The information on the authorized content servers may comprise a list of domain identifiers (e.g., domain names), a list of network addresses, a range of network addresses, or any other information. When the information on the authorized content servers is included in the digital watermark of the electronic file, the electronic file is protected from being shared over the communication network by unauthorized content servers.

Another embodiment of the invention comprises a method of controlling file sharing over the communication network using the digital watermarks. One step of the method includes receiving a copyright protected electronic file being downloaded by a content server to a requesting party over the communication network. Another step includes processing the electronic file to identify a digital watermark in the electronic file. Another step includes identifying information on content servers authorized to download the electronic file in the digital watermark. Another step includes processing the information on the authorized content servers to determine if the downloading content server is authorized to be downloading the electronic file to the requesting party. If the downloading content server is authorized, then another step includes allowing the download of the electronic file to continue. If the downloading content server is not authorized, then another step includes blocking the download of the electronic file.

The invention may include other exemplary embodiments described below.

### DESCRIPTION OF THE DRAWINGS

FIG. 1 illustrates a communication network in an exemplary embodiment of the invention.

FIG. 2 is a flow chart illustrating a method of protecting the electronic file from being shared over a communication network using digital watermarks in an exemplary embodiment of the invention.

FIG. 3 is a flow chart illustrating a method of controlling file sharing over a communication network using digital watermarks in an exemplary embodiment of the invention.

FIG. 4 illustrates another communication network in an exemplary embodiment of the invention.

### DETAILED DESCRIPTION OF THE INVENTION

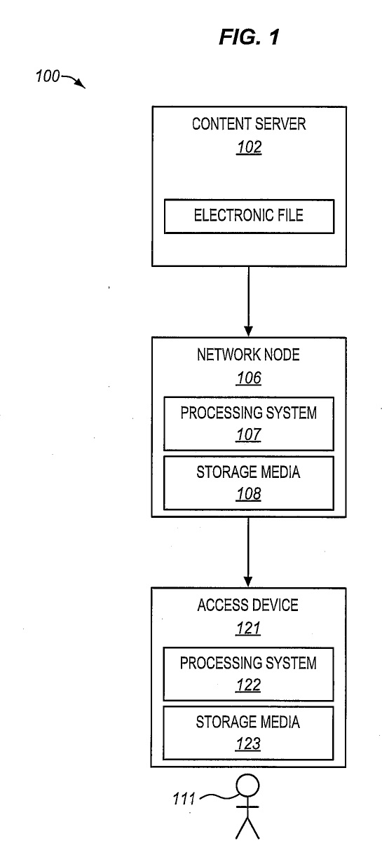

FIGS. 1-4 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may represent a wireline network, an IP Multimedia Subsystem (IMS) network, a packet-based network (IP network), or a wireless network. Communication network 100 is illustrated as including a content server 102, a network node 106, and a requesting party 111 operating an access device 121. Content server 102 comprises any server or system adapted to store electronic files and download the electronic files to requesting party 111 over communication network 100. The electronic files may comprise music, images, films, software, or other types of electronic files that are copyright protected. Network node 106 comprises any system, server, router, or other system in the communication path between content server 102 and access device 121 for the download of an electronic file. One example of network node 106 is an internet edge gateway. Access device 121 comprises an appropriately-enabled device to request the download of an electronic file over communication network 100. Access device 121 may comprise a PC, a wireless (mobile) phone, a PDA, a VoIP phone, a SIP phone, or any other type of access device. There may be other intermediate systems, servers, networks, etc, between access device 121 and content server 102, other than network node 106, that are not shown for the sake of brevity.

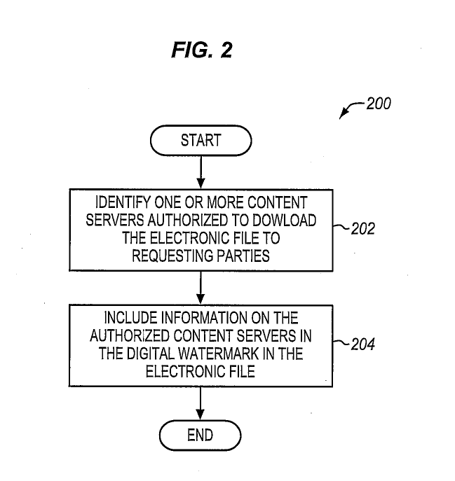

Content server 102 is illustrated as storing an electronic file. Assume that the electronic file was created with an embedded digital watermark. The digital watermark includes copyright information for the file. According to features and aspects herein, before the electronic file is accessible to content server 102, the copyright owner (e.g., creator of the electronic file, assignee of the copyright, etc) may protect the electronic file as described in FIG. 2.

FIG. 2 is a flow chart illustrating a method 200 of protecting the electronic file from being shared over communication network 100 using digital watermarks in an exemplary embodiment of the invention. The steps of method 200 will be described with reference to communication network 100 in FIG. 1. The steps of the flow chart in FIG. 2 are not all inclusive and may include other steps not shown.

One step 202 of method 200 includes identifying one or more content servers authorized to download the electronic file to requesting parties. The authorized content servers may be specified by the copyright owner. For instance, if the copyright owner agrees to allow particular content servers on the communication network 100, such as content server 102, to sell the electronic file, then the copyright owner would specify those content servers as authorized. Method 200 may then identify the authorized content servers based on input from the copyright owner.

Another step 204 of method 200 includes encoding, inserting, or otherwise including information on the authorized content servers in the digital watermark in the electronic file. The information on the authorized content servers may comprise a list of domain identifiers, a list of network addresses, a range of network addresses, or any other information. The information on the authorized content servers may be embedded in the digital watermark in an existing field of the watermark, or in a new field designated for such information.

Method 200 may be performed by a software product comprising an application stored on a storage media. The application may comprise instructions executable by a processing system resident on system or device of the copyright owner to operate as described above. For instance, the application may be a specialized application that the copyright owner may use to protect the electronic file after it is created. The application may be incorporated into the design software used by the copyright owner to create the electronic file. Some examples of instructions of the application are software, program code, and firmware. The instructions are operational when executed by the processing system to direct the processing system to operate in accordance with the invention. The term “processing system” refers to a single processing device or a group of inter-operational processing devices. Some examples of processors are computers, integrated circuits, and logic circuitry.

When the information on the authorized content servers is included in the digital watermark of the electronic file, the electronic file is protected from being shared over communication network 100 by unauthorized content servers (see FIG. 1). Assume that content server 102 receives a copy of the electronic file and makes the electronic file available for downloading (either legally or illegally). Further assume that requesting party 111 uses access device 121 to request the download of the electronic file from content server 102. Responsive to the request, content server 102 attempts to download the electronic file to the requesting party 111.

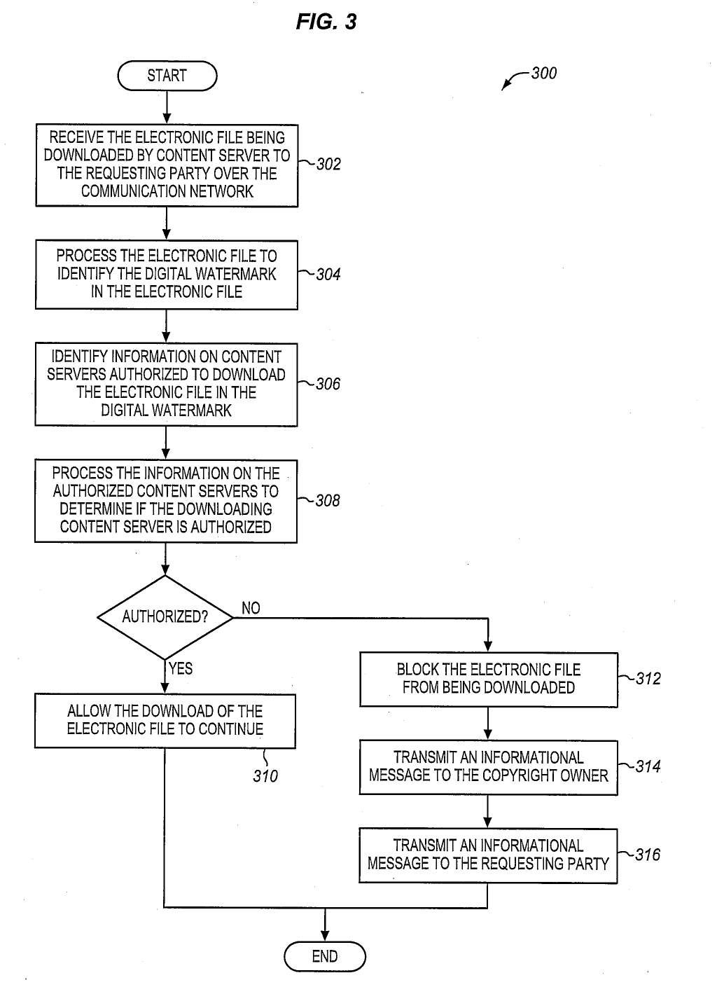

FIG. 3 is a flow chart illustrating a method 300 of controlling file sharing over the communication network 100 using the digital watermarks in an exemplary embodiment of the invention. The steps of method 300 will be described with reference to communication network 100 in FIG. 1. The steps of the flow chart in FIG. 3 are not all inclusive and may include other steps not shown. Method 300 may be performed by an application running on network node 106, access device 121 of requesting party 111, or another intermediate system or server not shown in FIG. 1.

Step 302 of method 300 includes receiving the electronic file being downloaded by content server 102 to requesting party 111 over communication network 100. Step 304 includes processing the electronic file to identify the digital watermark in the electronic file. Step 306 includes identifying information on content servers authorized to download the electronic file in the digital watermark. Step 308 includes processing the information on the authorized content servers to determine if the downloading content server 102 is authorized to be downloading the electronic file to requesting party 111. As an example, if the information on the authorized content servers comprises a list of domain identifiers, then step 308 may include identifying a domain identifier for the downloading content server 102, and comparing the domain identifier for the downloading content server 102 to the list of domain identifiers for the authorized content servers to determine if the downloading content server 102 is authorized to be downloading the electronic file.

If a determination is made that the downloading content server 102 is authorized, then step 310 includes allowing the download of the electronic file to continue. If method 300 is performed at network node 106, then network node 106 would forward the electronic file to access device 121 in step 308. If method 300 is performed at access device 121, then access device 121 would open the electronic message or perform another operation on the electronic file in step 308 as allowed by traditional copyright-protection mechanisms on access device 121.

If a determination is made that the downloading content server 102 is not authorized, then step 312 includes blocking the download of the electronic file. If the downloading of the electronic file is blocked, then method 300 may include the further step 314 of transmitting an informational message to the copyright owner indicating that the electronic file was being downloaded by an unauthorized content server 102. This informational message may also include a domain identifier, a network address, or another identifier of the unauthorized content server 102. The copyright owner may thus know who is illegally downloading the electronic file. Method 300 may also include the further step 316 of transmitting an informational message to requesting party 111 indicating that the electronic file was blocked from being downloaded to the requesting party 111.

Method 300 may be performed by a software product comprising an application stored on a storage media. The application may comprise instructions executable by a processing system resident on network node 106, access device 121, or another system to operate as described above.

By checking the authorized content servers in the digital watermark in the electronic file, unauthorized content servers may be blocked from downloading the electronic file. This provides an effective network-level copyright protection mechanism to reduce copyright infringement over the communication network 100 and consequently protect the copyright owner.

### EXAMPLE

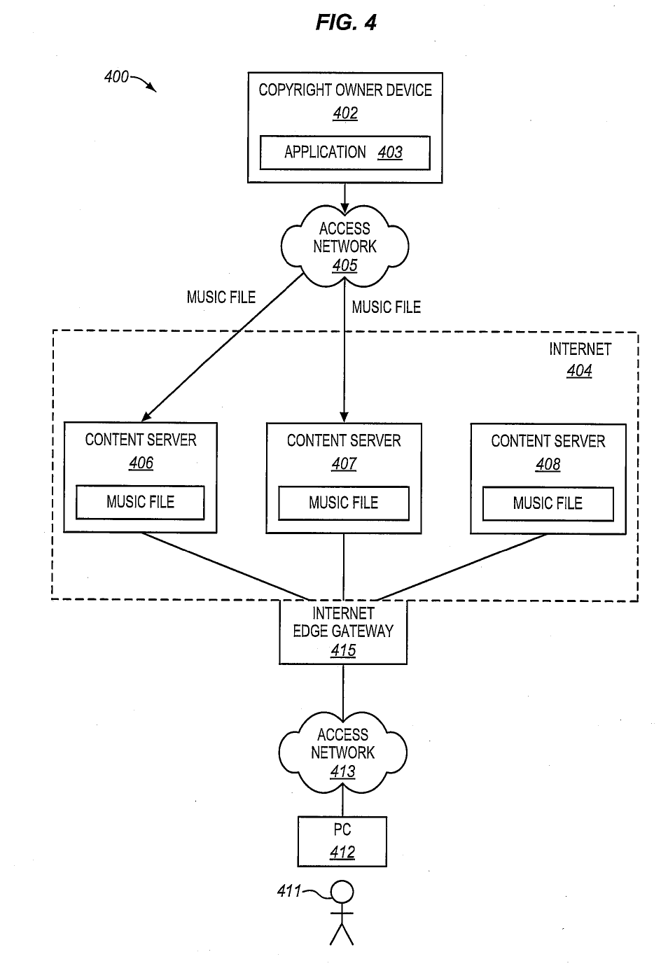

The following provides an example of protecting against illegal sharing of a music file. FIG. 4 illustrates another communication network 400 in an exemplary embodiment of the invention. Communication network 400 is illustrated as including a device 402 belonging to the copyright owner (e.g., creator of the music file, assignee of the copyright, etc) of the music file. Device 402 is connected to the internet 404 over an access network 405. The internet 404 is illustrated as including a plurality of content server 406-408. Content servers 406-408 are adapted to store electronic messages, such as the music file of the copyright owner. Communication network 400 is further illustrated as including a PC 412 of a party 411 requesting the music file. PC 412 connects to the internet 404 through an access network 413. Access network 413 may comprise an SS7 network, an IP network, or another type of network.

An internet edge gateway 415 acts as the interface between the internet 404 and the access network 413. The Internet Service Providers (ISPs) typically deploy gateways at the edge of the internet 404 as the bridge between the access networks 413 and the internet backbone network. The internet edge gateways 412 are normally routers that transport all kinds of data traffic between party 411 and the internet 404. With the access to the internet 404, party 411 may download various files from different content servers 406-408 (or web servers) of the internet 404. All the traffic downloaded by party 411 travels through internet edge gateway 415.

Assume for this example that the copyright owner wants to offer the music file for sale over the internet 404. The copyright owner selects one or more content servers 406-408 that are authorized to sell the music file. For this example, content servers 406 and 407 are authorized to sell the music file, such as through a web site designed to sell music. Content server 406 may be identified by a domain name, such as mymusic.com. Content server 407 may similarly be identified by a domain name, such as amazon.com.

Before the copyright owner makes the music file available on the internet 404, the copyright owner protects the music file from being illegally shared in the internet 404. To protect the music file, the copyright owner executes an application 403 in device 402 to either create an embedded digital watermark in the music file, or edit an existing digital watermark. According to features and aspects herein, application 403 identifies the content servers 406-407 that are authorized to download the music file to requesting parties. Application 403 may identify the content servers 406-407 by querying the copyright owner. Application 403 may provide a user interface that requests that the copyright owner enter information on the authorized content servers 406-407. In this example, the copyright owner enters the domain names for the authorized content servers 406-407. Application 403 then includes the domain names for the authorized content servers 406-407 in the digital watermark in the music file. Table 1 below illustrates an exemplary digital watermark that includes the domain names for the authorized content servers 406-407.

TABLE 1
Exemplary Digital Watermark:

| | |
|---|---|
| Copyright: | Sunny Music Company, |

http://www.sunny.com/copyright
mailto:copyright@sunny.com

| | |
|---|---|
| Author: | Allan Smith |
| Singer: | Jennifer Wolf |
| Composer: | Walter Stephens |
| Date: | January 1, 2006 |
| Version: | 1.1 |

Authorized Domain(s): amazon.com, mymusic.com

When the domain names of the authorized content servers 406-407 are included in the digital watermark of the music file, the music file is protected from being shared over the internet 404 by unauthorized content servers, such as content server 408. The copyright owner may then provide the music file to the authorized content servers 406-407. Content servers 406-407 store the music file and are able to download the music file to requesting parties over the internet 404 who choose to pay for the music file.

When the music file is sold over the internet 404, illegal copying or duplicating of the music file may result in unauthorized content servers, such as content server 408, also offering the music file (for sale or for free). Content server 408 is thus illustrated as also storing the music file in FIG. 4. The copy of the music file stored in content server 408 includes the embedded digital watermark and the domain names of the authorized content servers 406-407 as inserted by application 403.

Assume that requesting party 411 uses access device 412 to request the download of the music file from content server 408. Access device 412 transmits the request for the music file over access network 413 through internet edge gateway 415 for receipt by content server 408. Responsive to the request, content server 408 initiates the download of the music file to the requesting party 411. To download the music file the requesting party 411, content server 408 begins to transmit the music file through internet edge gateway 415.

Internet edge gateway 415 receives the music file being downloaded by content server 408. Internet edge gateway 415 processes the music file, such as header information or metadata of the music file, to identify the digital watermark in the music file. Internet edge gateway 415 identifies the information on the content servers 406-407 authorized to download the music file in the digital watermark. In this example, internet edge gateway 415 identifies a list of domain names for the authorized content servers 406-407 (mymusic.com and amazon.com). Internet edge gateway 415 also identifies the domain name for the downloading content server 408 (e.g., freemusic.com). Internet edge gateway 415 then compares the domain name for the downloading content server 408 to the list of authorized domain names provided in the digital watermark to determine if the downloading content server 408 is authorized to be downloading the file.

If internet edge gateway 415 determines that the downloading content server 408 is authorized, then internet edge gateway 415 allows the downloading of the music file to continue. If internet edge gateway 415 determines that the downloading content server 408 is not authorized, then internet edge gateway 415 blocks the download of the music file (e.g., terminates the present downloading of the music file).

In this example, the list of authorized domain names consists of mymusic.com and amazon.com. The domain name of the downloading content server 408 is freemusic.com. Because the domain name of the downloading content server 408 is not in the list of authorized domain names, internet edge gateway 415 blocks the download of the music file. Responsive to blocking the music file, internet edge gateway 415 transmits an informational message to the copyright owner and/or any proper authorities for internet copyright infringement indicating that the music file was being downloaded by an unauthorized content server 408. Internet edge gateway 415 also provides the identity of the unauthorized content server 408 in the informational message, which is freemusic.com. Internet edge gateway 415 also transmits an informational message to requesting party 411 indicating that the music file was blocked.

In another example, PC 412 may provide the digital watermark checking as described above in addition to internet edge gateway 415 or as an alternative to internet edge gateway 415. Other systems or servers in internet 404 or access network 413 not shown in FIG. 4 may also provide the digital watermark checking.

By checking the list of authorized domain names in the digital watermark, internet edge gateway 415, PC 412, or another system or server may block unauthorized content servers 408 from downloading the music file. Copyright infringement over the internet 404 may thus be reduced to protect the copyright owner.

Although specific embodiments were described herein, the scope of the invention is not limited to those specific embodiments. The scope of the invention is defined by the following claims and any equivalents thereof.

We claim:

1. A method of controlling file sharing over a communication network using digital watermarks, the method comprising:
receiving a copyright protected electronic file being downloaded by a content server to a requesting party over the communication network;
processing the electronic file to identify a digital watermark in the electronic file;
identifying information in the digital watermark on at least one content server authorized to download the electronic file;
processing the information on the at least one authorized content server to determine if the downloading content server is authorized to be downloading the electronic file to the requesting party;
allowing the download of the electronic file to continue responsive to a determination that the downloading content server is authorized; and
blocking the download of the electronic file responsive to a determination that the downloading content server is not authorized.

2. The method of claim 1 further comprising:
transmitting an informational message to the owner of the copyright protected electronic file indicating that the electronic file was being downloaded by an unauthorized content server responsive to a determination that the downloading content server is not authorized.

3. The method of claim 1 further comprising:
transmitting an informational message to the requesting party indicating that the electronic file was blocked responsive to blocking the download of the electronic file.

4. The method of claim 1 wherein the information on the at least one authorized content server was defined by the owner of the copyright protected electronic file.

5. The method of claim 1 wherein the information on the at least one authorized content server comprises a list of domain identifiers for the authorized content servers.

6. The method of claim 5 wherein processing the information on the at least one authorized content server to determine if the downloading content server is authorized to be downloading the electronic file to the requesting party comprises:
identifying a domain identifier for the downloading content server; and
comparing the domain identifier for the downloading content server to the list of domain identifiers for the authorized content servers to determine if the downloading content server is authorized to be downloading the electronic file.

7. The method of claim 1 wherein the information on the at least one authorized content server comprises a range of network addresses for the authorized content servers.

8. A software product for controlling file sharing over a communication network using digital watermarks, the software product comprising:
storage media adapted to store instructions; and
the instructions when executed by a processing system are adapted to control the processing system to:
receive a copyright protected electronic file being downloaded by a content server to a requesting party over the communication network;
process the electronic file to identify a digital watermark in the electronic file;
identify information in the digital watermark on at least one content server authorized to download the electronic file;
process the information on the at least one authorized content server to determine if the downloading content server is authorized to be downloading the electronic file to the requesting party;
allow the download of the electronic file to continue responsive to a determination that the downloading content server is authorized; and
block the download of the electronic file responsive to a determination that the downloading content server is not authorized.

9. The software product of claim 8 wherein the instructions are adapted to control the processing system to:
transmit an informational message to the owner of the copyright protected electronic file indicating that the electronic file was being downloaded by an unauthorized content server responsive to a determination that the downloading content server is not authorized.

10. The software product of claim 8 wherein the instructions are adapted to control the processing system to:
transmit an informational message to the requesting party indicating that the electronic file was blocked.

11. The software product of claim 8 wherein the information on the at least one authorized content server was defined by the owner of the copyright protected electronic file.

12. The software product of claim 8 wherein the information on the at least one authorized content server comprises a list of domain identifiers for the authorized content servers.

13. The software product of claim 12 wherein the instructions are adapted to control the processing system to:
identify a domain identifier for the downloading content server; and
compare the domain identifier for the downloading content server to the list of domain identifiers for the authorized content servers to determine if the downloading content server is authorized to be downloading the electronic file.

14. The software product of claim 8 wherein the information on the at least one authorized content server comprises a range of network addresses for the authorized content servers.

15. The software product of claim 8 wherein the instructions are executed by a processing system in a network node between the downloading content server and the requesting party.

16. The software product of claim 8 wherein the instructions are executed by a processing system in an access device being operated by the requesting party.

17. A method of protecting files from being shared over a communication network using digital watermarks, the method comprising:
identifying at least one content server authorized to provide a copyright protected electronic file to requesting parties; and
including information on the at least one authorized content server in a digital watermark in the electronic file.

18. The method of claim 17 further comprising:
querying the owner of the copyright protected electronic file for the information on the at least one authorized content server.

19. The method of claim 17 wherein the information on the at least one authorized content server comprises a list of domain identifiers for the authorized content servers.

20. The method of claim 17 wherein the information on the at least one authorized content server comprises a range of network addresses for the authorized content servers.
